(19) United States
(12) Patent Application Publication
(10) Pub. No.: US 2022/0275969 A1
(43) Pub. Date: Sep. 1, 2022

(54) HEAT STORAGE WATER DISPENSER SYSTEM

(71) Applicant: XIAMEN FILTERTECH INDUSTRIAL CORPORATION, XIAMEN Fujian (CN)

(72) Inventors: Wei Qiang Xu, XIAMEN Fujian (CN); Jian Yong Yan, XIAMEN Fujian (CN); Guan Bao Liu, XIAMEN Fujian (CN); Feng Bao Pan, XIAMEN Fujian (CN); Can Xiang Xu, XIAMEN Fujian (CN)

(73) Assignee: XIAMEN FILTERTECH INDUSTRIAL CORPORATION, XIAMEN Fujian (CN)

(21) Appl. No.: 17/570,383

(22) Filed: Jan. 7, 2022

(30) Foreign Application Priority Data
Mar. 1, 2021 (CN) 202110224424.6

(51) Int. Cl. F24H 1/18; F24H 1/20; B67D 1/08; F24D 3/10

(52) U.S. Cl. CPC F24H 1/188; F24H 1/202; B67D 1/0895; F24D 3/1008

(57) ABSTRACT

The invention discloses a heat storage water dispenser system, it comprises a heat storage tank, an overflow tank and a two-way valve device, the overflow tank is installed on the top of the heat storage tank, the overflow tank is provided with an exhaust port connected with the atmosphere, and the two-way valve device is installed between the heat storage tank and the overflow tank, an exhaust channel is formed between the two-way valve device and the overflow tank; the heat storage tank is provided with an expansion water channel and a hot water outlet channel, one end of the expansion water channel is connected with the heat storage tank, and the other end is connected with the overflow tank. Due to the existence of the expansion water channel and the design of consistent internal and external pressure of the heat storage tank of the present invention, the heat storage water dispenser system does not need to bear pressure in the heat storage tank, the water temperature range can be controlled in the range of 30-95 degrees, and can effectively solve the defects that the water outlet flows out without reason during heating and the water outlet delays when taking water.

### FIELD OF TECHNOLOGY

The invention relates to a heat storage water dispenser system.

### BACKGROUND

The existing heat storage device comprises a heat storage tank, an electric heating rod for heating water in the heat storage tank, a water inlet pipe and a water outlet pipe, and a pressure relief valve arranged on the water inlet pipe and the water outlet pipe. When water is heated, water vapor is generated in the heat storage tank to increase the pressure of the inner tank, the pressure relief valve can only be opened under a certain pressure. The heat storage tank needs to bear pressure, and the technical requirements of the heat storage tank are high and the cost is high. It leads to the following defects of the device: the water heating temperature range is 30-65 degrees, the water outlet flows out for no reason during heating, the water outlet delays when taking water, and the use altitude has a great impact on it. In view of the potential safety hazards of the existing heat storage devices, a defect solution with low safety cost is proposed.

### SUMMARY

In order to solve the above technical problems, the invention provides a heat storage water dispenser system.

The invention is realized by the following technical solution: a heat storage water dispenser system, it comprises a heat storage tank, an overflow tank and a two-way valve device, the overflow tank is installed on the top of the heat storage tank, the overflow tank is provided with an exhaust port connected with the atmosphere, and the two-way valve device is installed between the heat storage tank and the overflow tank, an exhaust channel is formed between the two-way valve device and the overflow tank; the heat storage tank is provided with an expansion water channel and a hot water outlet channel, one end of the expansion water channel is connected with the heat storage tank, and the other end is connected with the overflow tank.

Further, the bottom of the heat storage tank is provided with a water inlet, and the expansion water channel is connected with the water inlet.

Further, the expansion water channel is also connected with a venturi tube in series.

Further, the venturi pipe comprises a water inlet, a first water outlet and a second water outlet, the water inlet is connected with the raw water, the first water outlet is connected with the heat storage tank, and the second water outlet is connected with the overflow tank.

Further, a valve is also installed on the expansion water channel or the hot water outlet channel.

Further, the two-way valve device comprises a valve body and a sealing ball, the valve body comprises an inlet and an outlet, a holding space is formed in the valve body, the sealing ball is arranged in the holding space; when the sealing ball is located at the lower end of the holding space, the sealing ball forms a gap with the holding space, the upper end of the holding space is provided with an upper sealing ring, and the sealing ball can cooperate with the upper sealing ring to form a sealing state and block the connection between the inlet and the outlet.

Further, a lower support or a lower sealing ring is arranged below the holding space.

Further, an inner body is arranged in the valve body, the holding space is formed in the inner body, the sealing ball is arranged in the holding space.

Further, the heat storage tank has an opening, the overflow tank has a cavity, the two-way valve device comprises an inlet and an outlet, the two-way valve device extends into the cavity, the opening extends into the inlet and forms the exhaust channel, the outlet is connected to the top of the overflow tank.

Further, that the top of the overflow tank is provided with a convex part, the convex part forms a convex cavity, and the outlet is arranged in the convex cavity.

Due to the existence of the expansion water channel and the design of consistent internal and external pressure of the heat storage tank of the present invention, the heat storage water dispenser system does not need to bear pressure in the heat storage tank, the water temperature range can be controlled in the range of 30-95 degrees, and can effectively solve the defects that the water outlet flows out without reason during heating and the water outlet delays when taking water.

### BRIEF DESCRIPTION OF THE DRAWINGS

in order to illustrate the technical solution of the invention more clearly, the following is a brief description of the accompanying drawings which are necessary for the description of the embodiments or prior art. It is obvious that the accompanying drawings in the following description are only some embodiments of the invention and that other accompanying drawings can be obtained on the basis of these drawings without any creative effort on the part of a person of ordinary skill in the art

FIG. 1 is a schematic diagram of the connection of the heat storage water dispenser system of the present invention.

FIG. 2 is a schematic diagram of the state of the heat storage water dispenser system of the invention when it is in heating.

FIG. 3 is a schematic diagram of the state of the heat storage water dispenser system of the invention when the water is being taken.

FIG. 4 is a cross-sectional view of the two-way valve device of the present invention in the ventilated state.

FIG. 5 is a cross-sectional view of the two-way valve device of the present invention in a non-water state.

FIG. 6 is a connection structure diagram of the heat storage tank, overflow tank and two-way valve device of the invention.

FIG. 7 is a schematic diagram of the water and gas separation process of the heat storage tank, overflow tank and two-way valve device of the invention.

### DESCRIPTION OF THE EMBODIMENTS

The technical scheme in the embodiment of the invention will be clearly and completely described below in combination with the accompanying drawings in the embodiment of the invention. Obviously, the described embodiments are only part of the embodiments of the invention, not all of the embodiments of the invention. Based on the embodiments of the invention, all other embodiments obtained by those skilled in the art without creative work belong to the protection scope of the invention.

Referring to FIGS. 1 to 3 of the description, a heat storage water dispenser system includes a heat storage tank 5, an overflow tank 6 and a two-way valve device A, the overflow tank 6 is installed on the top of the heat storage tank 5, the overflow tank 6 is provided with an exhaust port 63 connected with the atmosphere, and the two-way valve device A is installed between the heat storage tank 5 and the overflow tank 6. When the heat storage tank 5 is in a heating state, an exhaust channel b1 is formed between the two-way valve device A and the heat storage tank 5 to make the internal and external pressure in the heat storage tank consistent and avoid pressure. When the user takes the hot water in the heat storage tank 5, the exhaust channel b1 is closed, and the user takes water without delay, which is very convenient. The heat storage tank 5 is provided with an expansion water channel 51, an exhaust channel b1 and a hot water outlet channel 53. The expansion water channel 51 is located at the bottom of the heat storage tank 5, and the exhaust channel b1 is arranged at the top of the heat storage tank 5; preferably, the heat storage tank 5 is provided with a water inlet channel 50, which is connected with the water inlet h at the bottom of the heat storage tank 5. A control valve b is installed on the water inlet channel 50 to control whether the raw water is connected with the water inlet h of the heat storage tank. At the same time, one end of the expansion water channel 51 is connected with the heat storage tank 5 and the other end is connected with the overflow tank 6, a valve 51a is also installed on the expansion water channel 51 or the hot water outlet channel 53. Preferably, the valve 51a is a one-way valve device. Further, the venturi 50b can be used to connect and integrate the water inlet channel 50 and the expansion water channel 51 into an integral water channel. The venturi 50b has a water inlet c1, a first water outlet c2 and a second water outlet c3, the water inlet c1 is connected with the raw water, the first water outlet c2 is connected with the water inlet h of the heat storage tank, and the second water outlet c3 is connected with the overflow tank 6.

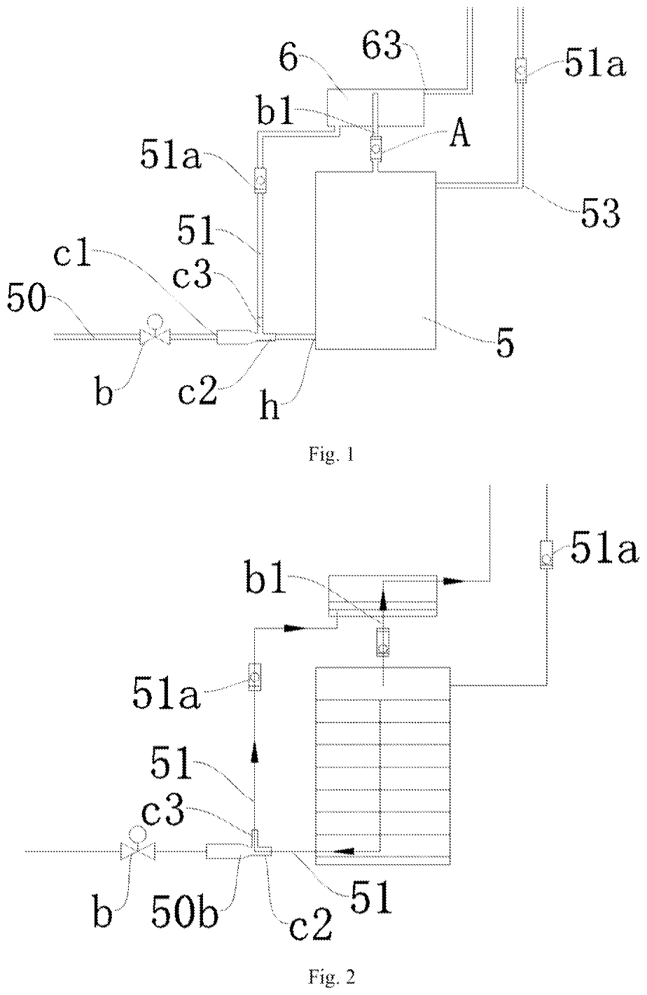

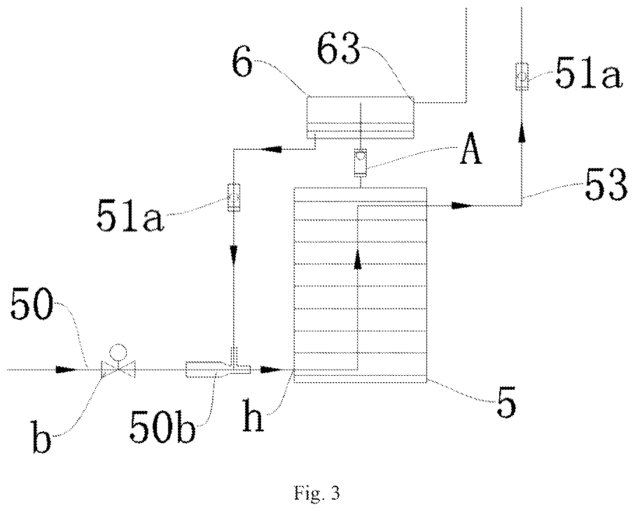

Referring to FIG. 2 and FIG. 3, when heating the water in the heat storage tank 5, the heat storage tank 5 is connected with the atmospheric pressure through the exhaust channel b1, and the water vapor is discharged into the atmosphere through the exhaust channel b1. There is no pressure in the heat storage tank 5. At the same time, the expansion of the water in the heat storage tank 5 due to heating enters the overflow tank 6 through the expansion water channel 51; when the user takes water through the hot water outlet channel 53, the exhaust channel bt is closed, and the water in the overflow tank 6 is recovered to the heat storage tank 5 through the expansion water channel 51 for recycling. The invention is connected with the heat storage tank by setting an overflow tank and using an exhaust channel and an expansion water channel, the expansion water channel is connected to the bottom of the heat storage tank (water inlet), the exhaust channel is connected to the top of the heat storage tank, and the overflow tank is provided with an exhaust port connected with the atmosphere; in this way, due to the existence of the expansion water channel and the design of consistent internal and external pressure of the heat storage tank, there is no need to bear pressure in the above heat storage tank, the water temperature range can be controlled within the range of 30-95 degrees, and it can effectively solve the defects that the water outlet flows out without reason during heating and the water outlet delays when taking water.

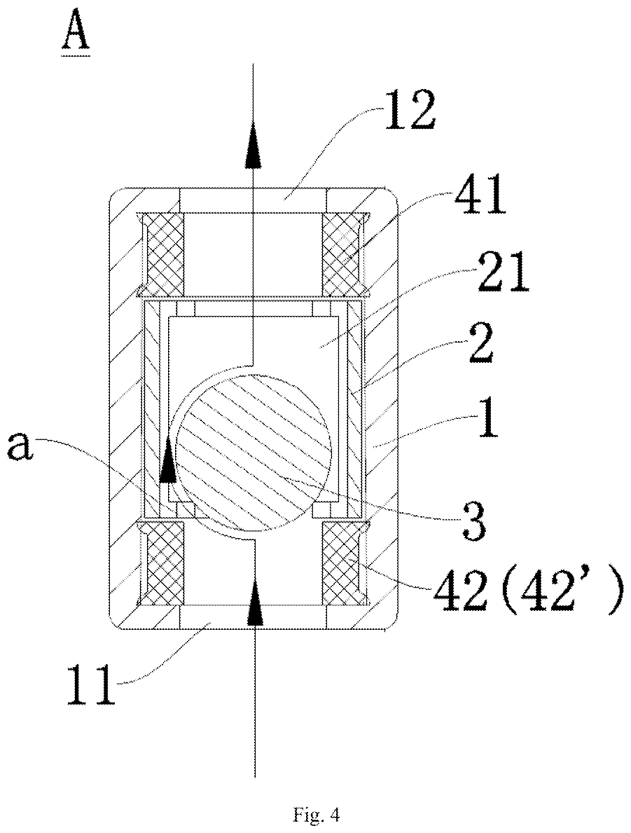

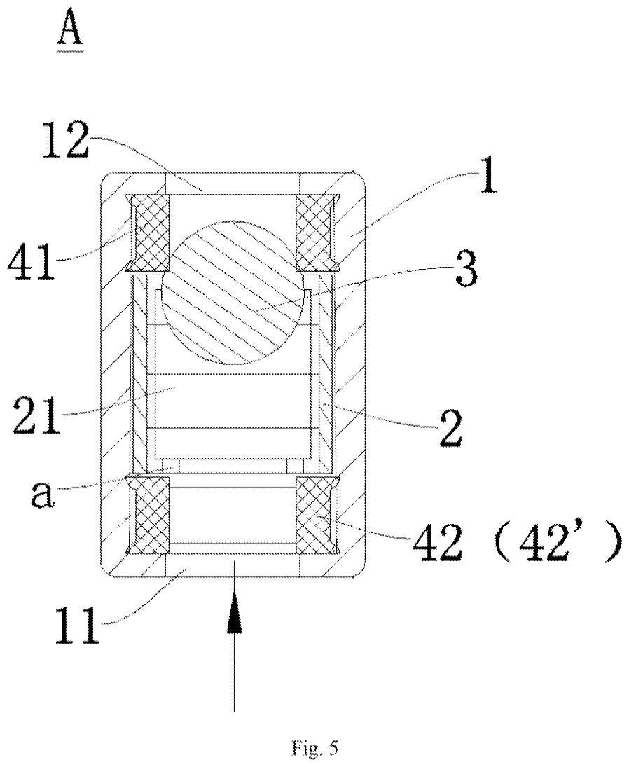

In a specific embodiment, referring to FIG. 4 and FIG. 5, the two-way valve device A is installed vertically when in use. The two-way valve device A includes a valve body 1, an inner body 2 and a sealing ball 3. The valve body 1 has an inlet 11 and an outlet 12, the inlet 11 is connected with the heat storage tank, the inner body 2 is arranged in the valve body 1, and the holding space 21 is a hollow structure open up and down, the sealing ball 3 is arranged in the holding space 21 of the inner body; in addition, an upper sealing ring 41 is placed at the upper end of the outer circumference of the inner body 2, and a lower support or lower sealing ring 42 is placed at the lower end. When the sealing ball 3 is at the lower end of the inner body 1 under the action of its own gravity, there is a gap a between the sealing ball 3 and the lower end of the inner body 1, and the gas can be discharged into the holding space 21 of the inner body from the gap a, and finally discharged from outlet 12 of the valve body. Of course, the two-way valve device may not include the inner body 2 and directly form the above holding space 21 in the valve body 1, the upper sealing ring 41 and the lower support (or lower sealing ring) 42 are placed at the upper and lower ends of the holding space 21. In this way, when the sealing ball is at the lower end of the holding space 21, the gap a for gas discharge is also formed between the sealing ball 3 and the valve body 1, which can also realize the function of discharging gas from the gap.

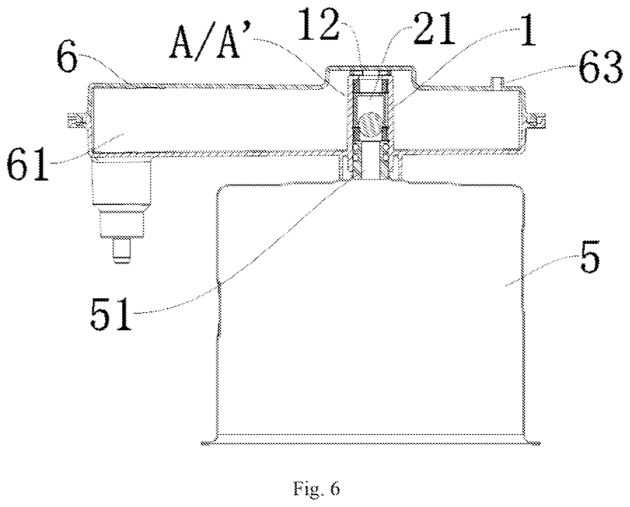

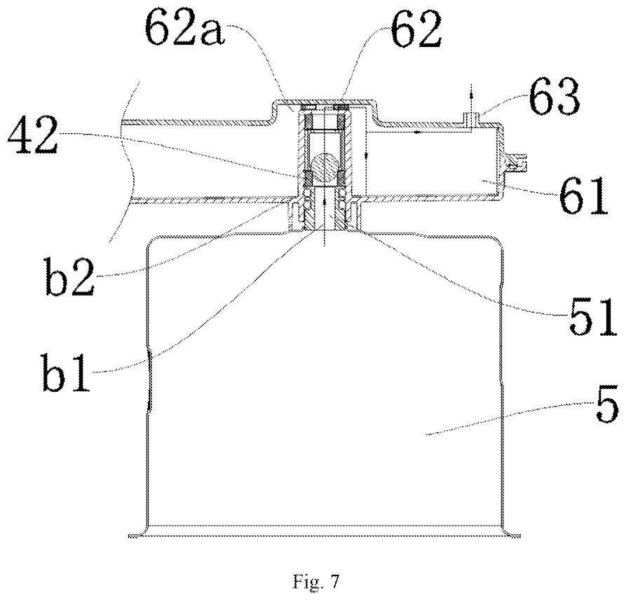

Further, the structure between the heat storage tank 5, the overflow tank 6 and the two-way valve device A can be shown in FIG. 6 and FIG. 7. The heat storage tank 5 has an opening 51, the overflow tank 6 has a cavity 61, the two-way valve device A extends into the cavity 61, the opening 51 of the heat storage tank extends into the valve body 1 of the two-way valve device, the opening 51 of the heat storage tank communicates with the holding space 21 of the valve body to form an exhaust channel b1, and a sealing washer B2 is arranged between the outer circumference of the opening SI and the valve body 1, ensure the tightness of the two connections; preferably, the upper end of the opening 51 is in direct contact with the lower support 42 or the lower sealing ring 42′. Further, the outlet 12 of the two-way valve device A is located on the top of the overflow tank 6, or the opening 51 of the heat storage tank is connected to the top of the overflow tank 6 through the exhaust channel b1. Specifically, the top of the overflow tank 6 is provided with a convex part 62, in which a convex cavity 62a higher than the maximum water level of the overflow tank 6 is formed, and the outlet 12 of the two-way valve device is located in the projection cavity 62a, that is, the height of the air outlet or outlet 12 of the exhaust channel b1 is higher than the maximum water level of the overflow tank. In this way, when the water vapor in the heat storage tank 5 is discharged into the protruding cavity 62a through the exhaust channel b1, the water vapor is separated in the overflow tank 6, so as to buffer the pressure of the water vapor and separate the water vapor, so that the temperature of the discharged gas is reduced, the exhaust becomes more gentle, and there is no risk of scald. In addition, an exhaust port 63 is arranged above the overflow tank 6, which is arranged at a certain distance from the outlet 12 of the two-way valve device, and the exhaust port 63 is connected with the faucet.

Referring to FIG. 7, the water vapor generated by the heat storage tank can be discharged into the overflow tank 6 from the exhaust channel b1, and water vapor separation is carried out in the overflow tank 6. The water generated during separation flows into the overflow tank 6, and the generated gas can be discharged into the atmosphere through the exhaust port 63, so as to effectively realize water vapor separation. The heat storage device of the invention can solve the defect of spraying high-temperature steam at the exhaust port of the faucet, and solve the potential safety hazards caused by high-temperature steam scalding users, reduce the exhaust temperature, make it softer, and improve the user experience.

The above description shows and describes the preferred embodiments of the invention. As mentioned above, it should be understood that the invention is not limited to the forms disclosed herein and should not be regarded as an exclusion of other embodiments, but can be used in various other combinations, modifications and environments, and can be changed through the above teaching or technology or knowledge in the related fields within the scope of the inventive concept described herein. The modifications and changes made by those skilled in the art shall be within the protection scope of the appended claims of the invention if they are not divorced from the spirit and scope of the invention.

What is claimed is:

1. A heat storage water dispenser system, characterized in that it comprises a heat storage tank, an overflow tank and a two-way valve device, the overflow tank is installed on the top of the heat storage tank, the overflow tank is provided with an exhaust port connected with the atmosphere, and the two-way valve device is installed between the heat storage tank and the overflow tank, an exhaust channel is formed between the two-way valve device and the overflow tank; the heat storage tank is provided with an expansion water channel and a hot water outlet channel, one end of the expansion water channel is connected with the heat storage tank, and the other end is connected with the overflow tank.

2. The heat storage water dispenser system according to claim 1, characterized in that the bottom of the heat storage tank is provided with a water inlet, and the expansion water channel is connected with the water inlet.

3. The heat storage water dispenser system according to claim 1, characterized in that the expansion water channel is also connected with a venturi tube in series.

4. The heat storage water dispenser system according to claim 3, characterized in that the venturi pipe comprises a water inlet, a first water outlet and a second water outlet, the water inlet is connected with the raw water, the first water outlet is connected with the heat storage tank, and the second water outlet is connected with the overflow tank.

5. The heat storage water dispenser system according to claim 1, characterized in that a valve is also installed on the expansion water channel or the hot water outlet channel.

6. The heat storage water dispenser system according to claim 1, characterized in that the two-way valve device comprises a valve body and a sealing ball, the valve body comprises an inlet and an outlet, a holding space is formed in the valve body, the sealing ball is arranged in the holding space; when the sealing ball is located at the lower end of the holding space, the sealing ball forms a gap with the holding space, the upper end of the holding space is provided with an upper sealing ring, and the sealing ball can cooperate with the upper sealing ring to form a sealing state and block the connection between the inlet and the outlet.

7. The heat storage water dispenser system according to claim 6, characterized in that a lower support or a lower sealing ring is arranged below the holding space.

8. The heat storage water dispenser system according to claim 6, characterized in that an inner body is arranged in the valve body, the holding space is formed in the inner body, the sealing ball is arranged in the holding space.

9. The heat storage water dispenser system according to claim 1, characterized in that the heat storage tank has an opening, the overflow tank has a cavity, the two-way valve device comprises an inlet and an outlet, the two-way valve device extends into the cavity, the opening extends into the inlet and forms the exhaust channel, the outlet is connected to the top of the overflow tank.

10. The heat storage water dispenser system according to claim 9, characterized in that the top of the overflow tank is provided with a convex part, the convex part forms a convex cavity, and the outlet is arranged in the convex cavity.
